(19) United States
(12) Patent Application Publication
(10) Pub. No.: US 2012/0248770 A1
(43) Pub. Date: Oct. 4, 2012

(54) High Altitude Wind Power Generator with Kite and Dual Purpose Circular Fan

(76) Inventor: Joonbum Byun, Gaithersburg, MD (US)

(21) Appl. No.: 13/078,952

(22) Filed: Apr. 2, 2011

(51) Int. Cl. H02P 9/04; F03D 9/00; B64C 31/06

(52) U.S. Cl. 290/44; 290/55

(57) ABSTRACT

Disclosed apparatus enables us to harvest wind power in high altitude atmosphere by taking advantage of kite, airfoil and dual purpose circular fan. The kite keeps the wind power turbines floated at high altitude when wind power is sufficient enough to sustain them. With help of stepping motor, the circular fan can be positioned either in vertical or horizontal position. In former position, the fan drives wind turbine to generate power as it is in angle of attack. In latter position, the turbine is converted into electrical motor with power provided from external source. It drives the fan providing floating forces when wind speed is too slow to keep the apparatus floated only by the kite or while the apparatus is ascending or descending.

### BACKGROUND OF THE INVENTION

Wind power generation is preferred to solar energy because it is available regardless of sunlight. One of disadvantage of wind power is that the wind turbine erected on mountains top or ridge side hurts the scenic view, which makes the nearby residents oppose to construction of the power plant.

However, despite the fact that the air density gets thinner as it gets higher, there is significantly abundant wind energy in high altitude sky than on ground due to two reasons. One is because the amount of energy contained in the wind increases as the cube of wind velocity increases. Second is that wind speed at high altitude is up to 70 times higher than ground wind speed depending on altitude and geographical location. Also, the wind speed is more constant throughout a day or season than on ground.

To set up a wind turbine at the high altitude sky for harvesting the abundant energy, not only lifting the apparatus up to the high altitude but also keeping it up there is a big technical challenge. The disclosed art enables us to reap the abundant energy in high sky without external energy source to keep the wind turbine stay afloat.

### BRIEF SUMMARY OF THE INVENTION

The disclosed art enables us to reap the abundant energy in high sky without external energy source to keep the wind turbine stay afloat. It takes advantage of lifting power by kite, airfoil shaped wing and wing flap when they encounter wind. To facilitate initial launching from ground to high altitude, the four fans facing upward are powered by external electricity source. But when the apparatus reaches to targeted altitude, the fans are converted to wind turbine to generate power.

### FIELD OF INVENTION

Current invention is related with renewable energy generation from wind power at high altitude sky.

### DESCRIPTION OF RELATED ART

To harvest the abundant energy at the high altitude sky, there has been many attempts as shown in U.S. Pat. Nos. 4,165,468 by Fry et al, 4,572,962 by Shepard, 4,659,940 by Shepard, 6,254,034 by Carpenter, 6,523,782 by Ragner. Especially the prior art of U.S. Pat. No. 6,781,254 by Bryan William Roberts, cannot fully harvest the wind energy because the rotor blades does not face the wind direction in right angle.

Some suggested using helium gas filled balloon to lift the turbine. Feasibility of the idea is questionable because it is uncertain whether it can stay afloat even in thin cold air environment for indefinite time. It might need to bring down the whole system to refill the gas periodically.

### DETAILED DESCRIPTION OF INVENTION

Four sets of fans 102 in FIG. 1 connected to motor/generators 101 are used for dual purpose. When it is in horizontal position facing upward as shown in FIG. 2, it is providing lifting forces to the apparatus just like the helicopter propeller does on its top. The electrical motor/generator 101 attached to the fan 102 is powered by external source while the apparatus is in ascending or descending mode.

If the apparatus reaches to its targeted altitude, it transforms itself to power generator. The fans 102 tilt to vertical position as shown in FIG. 1 facing the wind 111 blowing toward the apparatus. The motor/generator 102 connected to the fan 101 is converted into electrical power generator by built in computerized controller 130. The fan 102, driven by the wind 111, provides rotating force to the generator 101 enabling it to produce electricity.

The tilting operation between vertical and horizontal position is actuated by a stepping motor 104 which is controlled by the built-in computerized controller system 130. The stepping motor 104 also keeps the fan frame 105 in vertical position while the apparatus is in power generation mode. It is controlled by the controller system 130 which produces control signal to stepping motor in response to the input from gravity sensor attached to fan frame 108. Horizontal portion of fan frame is shaped as an airfoil so that it also provides lifting power just like the kite 109 does.

Various kinds of sensors are embedded in the apparatus. Gravity sensor 108 is attached to fan frame 105 to detect whether the fan 102 is in horizontal or vertical position. Altitude sensor is fixed in main frame and measures current altitude of the apparatus above sea level. Tension sensor 103, located between kite string 110 and main frame 106 measures the force that the kite 109 is pulling the apparatus upward. Wind speed sensor 112 counts the current wind speed. Fan speed sensor keeps track of fan speed. All the signals acquired by the above sensors are electrical one and are fed to computerized controller 130 embedded in the apparatus. FIG. 3 shows internal wiring diagram among those sensors, motor/generators 101, stepping motors 104 and main controller 130. Commands from human operator are also provided to the controller 130.

Output from the controller 130 goes to each of the four fan motor 101 and fan frame stepping motor 104. The latter positions the fan frame 105 in either vertical or horizontal standing.

Main function of the controller 130 is to decide position of the fans 102 in either vertical or horizontal based on all those inputs. If human operator commands the apparatus to rise from ground, the controller 130 issues signal to the stepping motor 104 to actuate revolution of wing frame 113 to pose in vertical position, as shown in FIG. 2, so that the four fans 102 attached to it can face upward.

While rising, the controller 130 keeps track of signal from both of the gravity sensors 108 107 in fan frame and main frame, respectively, to maintain all the fan blades facing upwards be parallel to ground. Assuming there is a virtual plane covering all the fan blades, if the virtual plane is slanted to one side, the gravity sensor on fan frame 108 catches the angle between horizontal plane and the virtual plane. The controller 130 is notified of the angle value, does some computation and issues signal to the motor at the downside to run faster. In this way, the controller 130 corrects the virtual plane to stay in horizontal position in real time.

There are three sources of lifting power that maintain apparatus's altitude without any electrical or physical aid from external source except the wind. When wing frame 113, shaped like airfoil, is in horizontal position as in FIG. 1, it produces lifting power if it meets wind flow 111 just like airplane wing does. Second source of lifting force is the kite 109. When the apparatus is in high altitude, being pushed by the wind, it drags the apparatus upward. Third one is the skirt wing 106 which not only provides the lifting power but counters the force that pushes the fan 102 backward when it is driven by wind. The wind hitting the fan blade creates rotational force in one direction and the wind beating the wing skirt 106 exerts rotational force in opposite direction. As the apparatus is attached to the tether wire 120, one of the two forces nullifies the other.

It should be noted that the wind speed in high altitude is more than a dozen times faster than in ground. After the apparatus takes off the ground and until it reaches to its

### BRIEF DESCRIPTION OF DRAWING

FIG. 1 shows when the embodiment of current invention is in power generation phase at high altitude sky. Fan blade 102 is attached to wind generator (turbine) 101, which is framed to wing frame 113. The wing frame 113 is in shape of airfoil so that it can provide lifting force when the fan is in vertical position. The gravity sensor 108 detects current pose of wing frame 113 and reports to central controller 130. Wing frame 113 can be rotated 360 degree driven by stepping motor 104 along with the fan frame 105, motor/generator 101 and fan 102. Motor/generator 101 is convertible between motor and generator by external control. Kite 109 is attached to the two upright wing 114 through a tension sensor 103. It not only provides the apparatus lifting force but also helps main frame 106 of the apparatus maintain near upright position. The lifting force exercised by kite 109 and wing frame 113 keeps the apparatus at high altitude without external aid. Two upright wing 114 keeps the apparatus face the wind. The apparatus's main frame, composed of two upright wing 114 and wing skirt 106, is tethered to the ground by the wire 120. Conductor for control signal and electricity run between the apparatus and ground station along the wire 120.

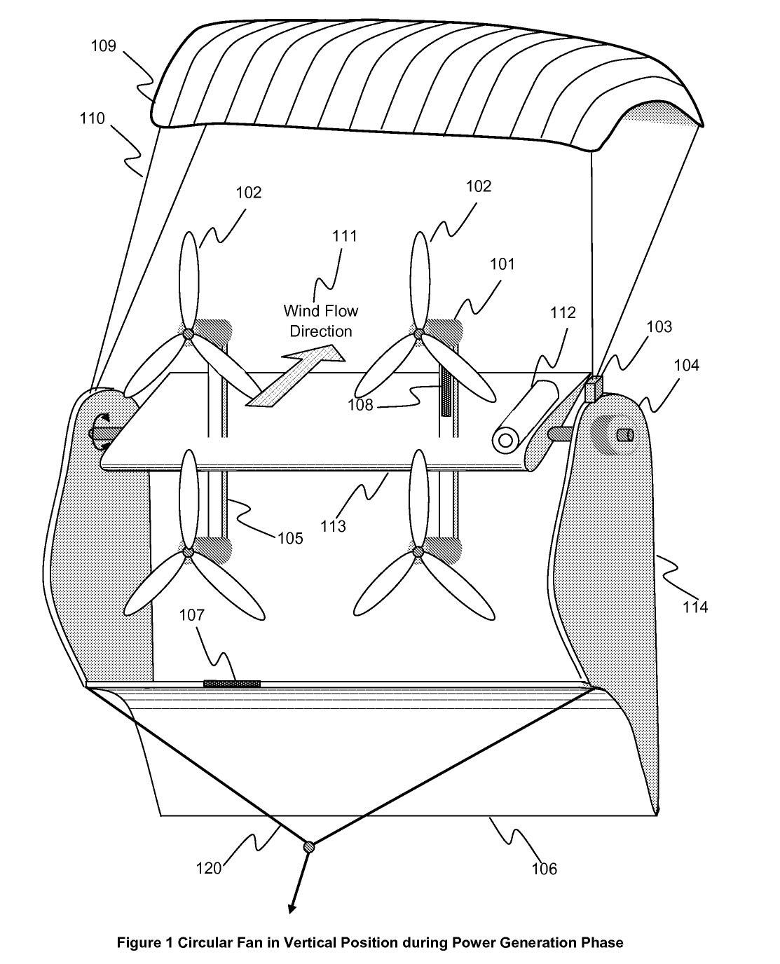

FIG. 2 shows when the embodiment of current invention is in ascending or descending phase to or from high altitude sky. All the components in FIG. 2 are exactly same except that the fan 102 is in horizontal position and the fan motor 101 is driven by external power source.

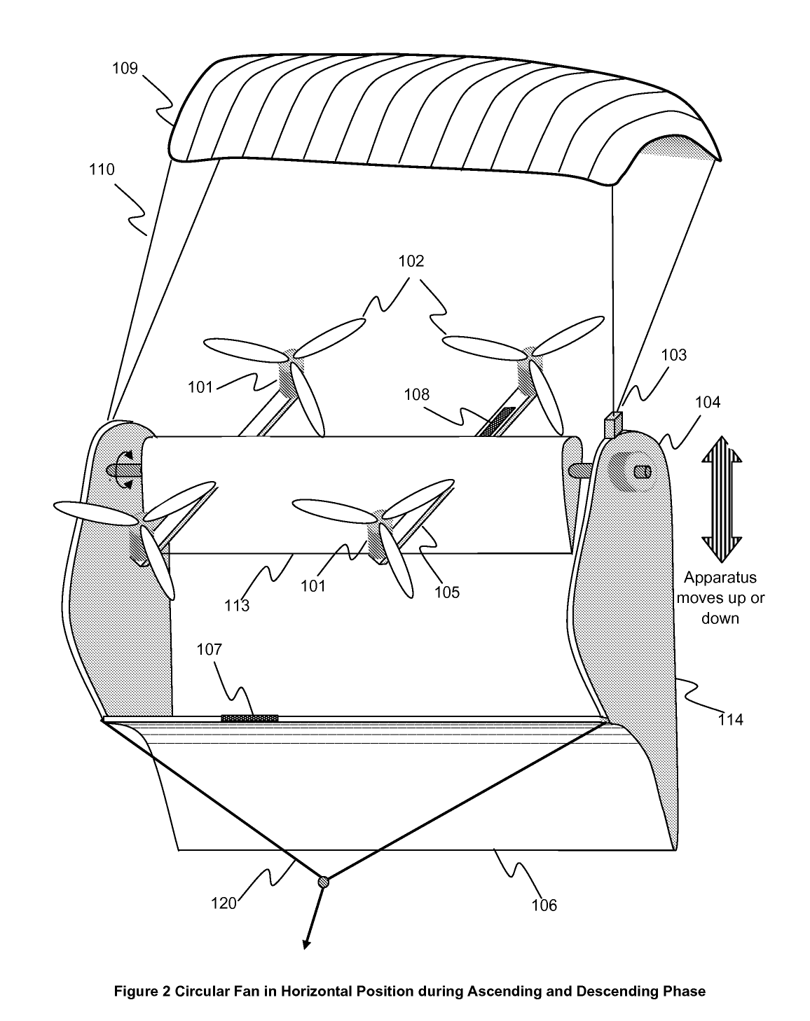

FIG. 3 depicts wiring diagram of power and control line among various sensors, stepping motor and motor/generators.

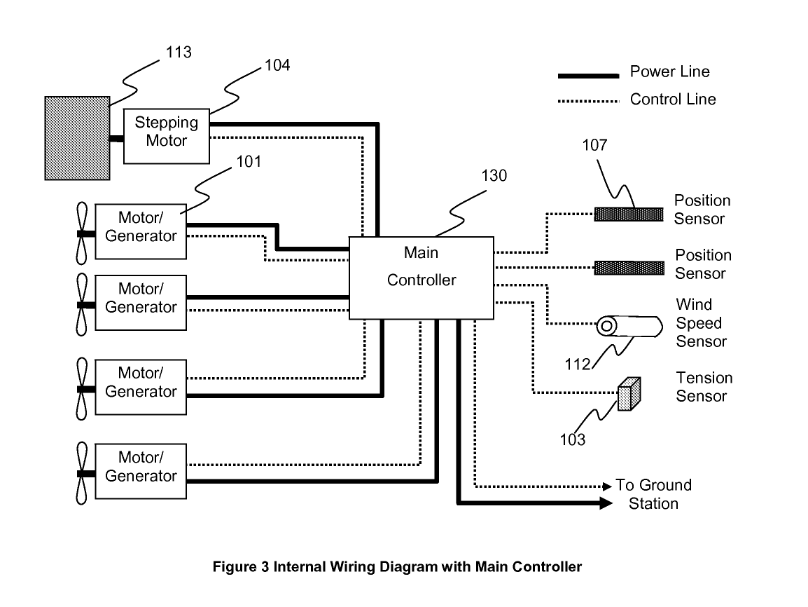

What is claimed are:

1. A structure with four or more of fans attached to convertible motor generator, again attached to wing frame that can be rotated by stepping motor which is fixed to upright wing which is attached to wing skirt.
The fans are used for dual purposes; one for lifting the apparatus when the fan blade is in horizontal position and the other for generating the power when the fan blade is in vertical position.
A gravity sensor attached to fan frame senses whether the fan is in vertical, horizontal or in between position and another gravity sensor attached to wing skirt senses whether the apparatus is in parallel position to ground. They both feed sensed position to central controller.
Airfoil shaped wing frame provides lifting force when the fan blade is in horizontal position
Kite is attached to two upright wing to provide additional lifting force
Wing skirt for lifting the apparatus and counter-forcing the tilting force which is exerted on the fan blade.

2. A built-in controller system embedded in the said structure that takes position signal from two or more of gravity sensors, wind speed sensor, kite tension sensor and command signal from human operator processes the input signal to provide control signal to stepping motor and four or more to the motor/generator.
Upon human operators command to lift from ground, the controller issues command signal to stepping motor to rotate the wing frame in vertical position so that the fan blades are in horizontal position, another command signal to all the motor/generator to function as motor and provides all of the motors with electrical power furnished from external sources such as utility power, battery or portable generator.
While rising, the controller continuously monitors signal from all the gravity sensors, process them with algorithm that adjust separately each of the power level provided to all the motor/generator so that the fan blades are maintaining parallel position to the ground.
Upon reaching the targeted altitude or meeting targeted wind speed, the controller issues command signal to stepping motor to change wing frame position from vertical to horizontal so that the fan blades face the wind, stops providing electrical power to the motor/generator and sends another signal to motor/generator to convert to power generator.
While generating power, the controller continuously gathers signal from all the gravity sensors, process them to send signal to stepping motor so that the wing frame always maintains horizontal position regardless of the position of upright wing.
The generated power from the four or more of the generator are collected together and transmitted to ground station.
